(19) United States
(12) Patent Application Publication
(10) Pub. No.: US 2019/0246404 A1
(43) Pub. Date: Aug. 8, 2019

(54) METHOD AND APPARATUS FOR CONFIGURING WIRELESS RESOURCE ALLOCATION INFORMATION

(71) Applicant: ZTE CORPORATION, Shenzhen, GD (CN)

(72) Inventors: Nan Zhang, Shenzhen (CN); Yu Ngok Li, Shenzhen (CN); Jian Li, Shenzhen (CN)

(21) Appl. No.: 16/326,904

(22) PCT Filed: Aug. 21, 2017
(86) PCT No.: PCT/CN2017/098287

§ 371 Date: Apr. 16, 2019

(30) Foreign Application Priority Data
Aug. 20, 2016 (CN) 201610696571.2

(51) Int. Cl. H04W 72/04; H04W 72/12; H04L 27/26; H04L 5/00

(52) U.S. Cl. CPC H04W 72/0493; H04L 5/0053; H04L 27/2649; H04W 72/1273

(57) ABSTRACT

The present invention provides a method and apparatus for configuring wireless resource allocation information. The method includes: a base station sends, to a terminal by means of signaling, currently-transmitted N transmission code word groups and wireless resource allocation information to which the transmission block groups belong, N≥1.

### CROSS-REFERENCE TO RELATED APPLICATION

This application is the 371 application of PCT Application No. PCT/CN2017/098287, filed Aug. 21, 2017, which is based upon and claims priority to Chinese Patent Application No. 201610696571.2, filed Aug. 20, 2016, the entire contents of which are incorporated herein by reference.

### TECHNICAL FIELD

The present disclosure relates to the communication field, and more particularly, to a method and apparatus for configuring wireless resource allocation information.

### BACKGROUND

In the Long Time Evolution-Advanced (LTE-A) system, for improving a performance of a cell-edge user, a Coordinated Multi-Point (CoMP) transmission technology is introduced. Through coordination of multiple adjacent base stations or nodes, the CoMP technology inhibits the same frequency interference of adjacent cell received by the cell-edge user and improves the business quality of the cell-edge user. The CoMP technology is mainly divided into three types: Joint Transmission (JT), Dynamic Point Selection/Dynamic Point Blanking (DPS/DPB), and Coordinated Scheduling Coordinated beam forming (CSCB).

In existing systems, the sending end completes unified instructions of the wireless transmission Resource Block (RB) occupied by the currently transmitted code word/transmission block (maximum of 2) by configuring a resource allocation related signaling (Resource allocation field) included in the DCI of the PDCCH/EPDCCH. Therefore, in the JT technology application, multiple code words/transmission blocks can only be transmitted by the serving cell and the coordinated cell on the same frequency domain resource. In addition, in the existing Non-coherent JT, precoding matrixes corresponding to different code words/transmission blocks are independently determined by the corresponding TP according to link channel characteristics fed back by the UE, thus its orthogonality is also difficult to be guaranteed, which further limits the system performance under JT transmission.

Meanwhile, the physical downlink shared channel resource element mapping (PDSCH RE MAPPING) and QCL indication corresponding to the wireless transmission resource are also uniformly indicated by signaling, and are impossible to be adjusted according to a current allocation status of each resource, especially under the JT technology, when the same resource is allocated to different transmission nodes, the existing signaling cannot differentially configure its corresponding PDSCH RE MAPPING and QCL, thus affecting an estimation of the link channels from different TPs and the accuracy of data demodulation by the terminal.

Therefore, in order to break these performance limitations, it is necessary to be able to adaptively complete the configuration of the resource occupied by each of the multiple code words/transmission blocks, according to a load of the current system/TP, channel characteristics fed back by different links and other conditions. However, at present, there is no effective solution for implementing the configuration of signaling related to resource allocation in the related art.

This section provides background information related to the present disclosure which is not necessarily prior art.

### SUMMARY

Embodiments of the present disclosure provide a method and apparatus for configuring wireless resource allocation information, in order to at least solve the problem in the related art that there is no effective solution for implementing signaling configuration related to resource configuration.

According to an embodiment of the present disclosure, there is provided a method for configuring wireless resource allocation information, including: a base station sends, to a terminal by signaling, wireless resource allocation information to which currently-transmitted N transmission code word groups and transmission block groups belong, N≥1.

According to another aspect of the embodiments of the present disclosure, there is provided a configuration method of wireless resource allocation information, including: signaling received by the terminal; the terminal acquires resource configuration information of each of the currently received N transmission code word groups or transmission block groups from the signaling.

According to another aspect of the embodiments of the present disclosure, there is provided a configuration apparatus of wireless resource allocation information, which is applied to a base station, including: a sending module, configured to send to a terminal by signaling, wireless resource allocation information to which currently-transmitted N transmission code word groups and the transmission block groups belong, N≥1.

According to another embodiment of the present disclosure, a storage medium is provided. The storage medium is arranged to store program code for performing the following steps: the base station sends, to a terminal by signaling, wireless resource allocation information to which currently-transmitted N transmission code word groups and the transmission block groups belong, N≥1.

According to another embodiment of the present disclosure, another storage medium is provided. The storage medium is arranged to store program code for performing the following steps: signaling received by the terminal; the terminal acquires resource configuration information of each of the currently received N transmission code word groups or transmission block groups from the signaling.

According to the embodiment of the present disclosure, the base station sends, to a terminal by signaling, wireless resource allocation information to which currently-transmitted N transmission code word groups and the transmission block groups belong, therefore, it is able to adaptively configure to complete the resource occupied by each of the code words/transmission blocks, according to the current system/TP load, channel characteristics of different link feedback and other conditions, and solve the problem that the signaling configuration related to resource configuration is not implemented in the related art.

This section provides a summary of various implementations or examples of the technology described in the disclosure, and is not a comprehensive disclosure of the full scope or all features of the disclosed technology.

### BRIEF DESCRIPTION OF THE DRAWINGS

The drawings described herein are used to provide further understanding of the present disclosure, and constitute a part of the present disclosure. The exemplary embodiments of the present disclosure and descriptions thereof are for the purpose of explaining the present disclosure, but are not intended to unduly limit the present disclosure. In the drawings:

FIG. 1 is a schematic diagram showing a resource allocation mode adopted by the transmission code word group/transmission block group according to an embodiment of the present disclosure;

FIG. 2 is a flowchart showing a method for configuring wireless resource allocation information according to an embodiment of the present disclosure;

FIG. 3 is a block diagram showing an apparatus for configuring wireless resource allocation information according to an embodiment of the present disclosure;

FIG. 4 is a flowchart showing another method for configuring wireless resource allocation information according to an embodiment of the present disclosure;

FIG. 5 is a block diagram showing another apparatus for configuring wireless resource allocation information according to an embodiment of the present disclosure;

FIG. 6 is a schematic diagram showing a transmission process of a resource configuration signaling according to an embodiment of the present disclosure;

FIG. 7 is a schematic diagram showing contents indicated by the first signaling and the second signaling according to an embodiment of the present disclosure;

FIG. 8 is a schematic diagram showing a first type of resource configuration according to an embodiment of the present disclosure;

FIG. 9 is a schematic diagram showing a second type of resource configuration according to an embodiment of the present disclosure;

FIG. 10 is a diagram showing generation of resource allocation states in a third type of resource configuration according to an embodiment of the present disclosure;

FIG. 11 is a schematic diagram showing a state of a fourth type of resource configuration according to an embodiment of the present disclosure;

FIG. 12 is a schematic diagram showing a state of a fifth type of resource configuration according to an embodiment of the present disclosure;

FIG. 13 is a schematic diagram showing a state of a sixth type of resource configuration according to an embodiment of the present disclosure.

### DETAILED DESCRIPTION

The present disclosure will be described below with reference to drawings and embodiments. It should be understood that if there is no conflict, the embodiments and the features in the embodiments in the present disclosure can be combined with each other.

It should be noted that the terms “first”, “second” and so on in the description and claims of the present disclosure are used for distinguishing similar objects, rather than describing a specific sequence or order.

With respect to the problem that the existing signaling configuration cannot characterize the wireless resource configuration corresponding to each of the multiple transmission code words or transmission block groups, the embodiments of the present disclosure provide a new signaling configuration method. Through this method, the wireless resource configuration employed by each of the currently transmitted code words/transmission blocks (groups) can be indicated. Through the technical solution of the present disclosure, the system can complete the resource allocation of multiple transmission code words/transmission blocks (groups), improve the flexibility of resource scheduling of the wireless communication system, and optimize the system performance. It should be understood that in the embodiments of the present disclosure, each transmission code word group or transmission block group may include one or more elements, for example, one transmission code word group may include one or more code words, and one transmission block group may include one or more transmission blocks.

If there is no conflict, the embodiments and the features in the embodiment in the present disclosure can be combined with each other.

For ease of understanding, before the description of the embodiments of the present disclosure, the wireless resource allocation modes corresponding to different code words/transmission blocks involved in the embodiments of the present disclosure are first described.

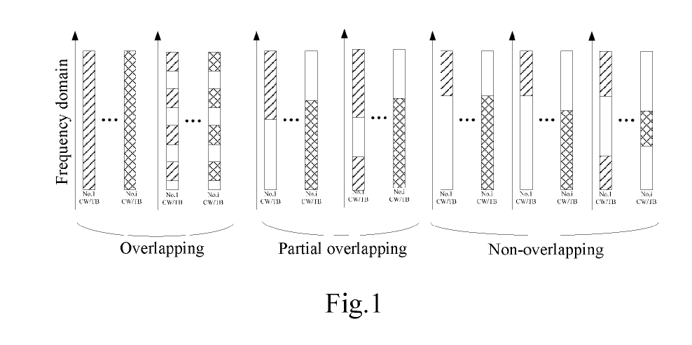

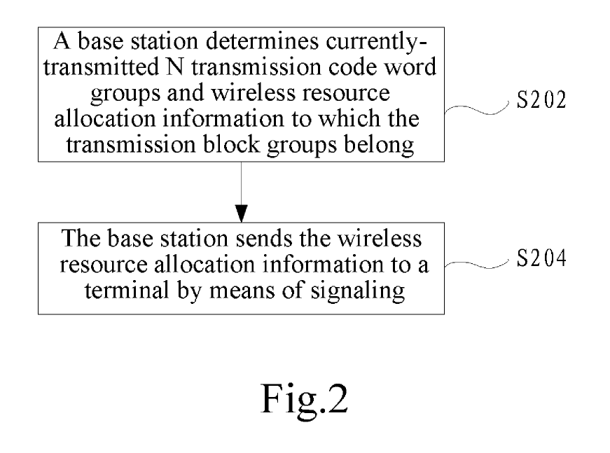

FIG. 1 shows wireless resource allocation modes corresponding to different code words/transmission blocks respectively adopted in this embodiment, where the abscissa indicates numbers of the currently transmitted code word/transmission block groups, and the ordinate indicates a frequency domain coordinate. As shown in FIG. 1, relationships among the wireless resources allocated for different code words/transmission blocks may be mainly divided into following modes: completely overlapping, partially overlapping, and completely non-overlapping, and the three modes may be further divided into multiple subclasses (including but not limited to the subclasses shown in the figure) according to whether the resources occupied by the different code words/transmission blocks for transmission are consecutive or not.

The embodiments of the present disclosure provide a method for configuring wireless resource allocation information. The transmission method includes the following steps.

In S202, the base station determines wireless resource allocation information to which currently transmitted N transmission code word groups or transmission block groups belong respectively, N≥1.

In S204, the base station sends the above-mentioned wireless resource allocation information to the terminal by a signaling.

In the specific implementation process, the sending end may send the above-mentioned signaling to the terminal on a downlink control channel through an air interface in a periodic or aperiodic mode.

The information contained in the signaling includes, but is not limited to: wireless resource allocation mode group to which each of the currently transmitted N transmission code words/transmission block groups belongs and the corresponding wireless resource allocation mode, the corresponding transmission node, and the PDSCH RE MAPPING and QCL modes corresponding to each resource scheduling basic unit or unit group.

Optionally, the base station sending, to the terminal by the signaling, the wireless resource allocation information to which the currently-transmitted N transmission code word groups and the transmission block groups belong, includes: the base station sending, to the terminal, the wireless resource allocation mode group to which the N transmission code word groups or transmission block groups belong, and the wireless resource allocation mode corresponding to each of the N transmission code word groups or transmission block group.

Optionally, the N transmission code word groups or transmission block groups are jointly transmitted by one or more base stations, for example, are cooperatively sent by multiple base stations.

Optionally, the wireless resource allocation mode used for allocating wireless resource for each transmission code word group or transmission block group includes at least one of the followings: the wireless resource completely overlapping, the wireless resource partially overlapping, or the wireless resource completely non-overlapping.

Optionally, the wireless resources are allocated for the N transmission code word groups or transmission block groups by a mode of resource allocation basic unit or resource allocation basic unit group.

Optionally, the base station sending, to the terminal by the signaling, the wireless resource allocation information to which the currently-transmitted N transmission code word groups or transmission block groups belong, includes: the base station sending the wireless resource allocation mode group to the terminal by a first signaling; and the base station sending the wireless resource allocation mode by a second signaling.

Optionally, the first signaling and/or the second signaling includes: a semi-static system signaling (e.g., a RRC signaling), and DCI (Downlink Control Information).

Optionally, when the wireless resources allocated for the N transmission code word groups or transmission block groups adopt the completely overlapping mode, the second signaling carries indication information indicating whether each resource allocation basic unit or resource allocation basic unit group is scheduled.

Optionally, when the wireless resources allocated for the N transmission code word groups or transmission block groups adopt the completely overlapping mode, the wireless resources may be divided into mutually independent K groups, and the second signaling carries a resource group number including a wireless resource allocation mode group corresponding to the current N code words/groups or transmission block groups, K≥N.

Optionally, when the wireless resources allocated for the N transmission code word groups or transmission block groups adopt the completely non-overlapping mode, the second signaling carries N+1 states of a resource allocation basic unit or a resource allocation basic unit group, where the N+1 states means one resource allocation basic unit or resource allocation basic unit group is not scheduled, or is scheduled to a n^{th} transmission code word group or transmission block group, 1≤n≤N.

Optionally, when the wireless resources allocated for the N transmission code word groups or transmission block groups adopt the completely non-overlapping mode, the wireless resources are divided into N groups which are independent of each other, and the N groups are allocated to N transmission code word groups or transmission block groups in a non-multiplexed mapping mode, which includes a one-to-one mapping mode between the wireless resource group and the transmission code word group or transmission block group, K≥N. The second signaling includes a resource group number corresponding to each transmission code word group or transmission block group.

Optionally, when the wireless resources allocated for the N transmission code word groups or transmission block groups adopt the partially overlapping mode, the second signaling includes N sets of contents having the same or different formats for characterizing a resource feature allocated for the corresponding code block or transmission block group one by one, wherein the n^{th} set of content includes two states of whether each resource allocation basic unit or resource allocation basic unit group is allocated to the n^{th} transmission code word group or transmission block group, 1≤n≤N.

Optionally, when the wireless resources allocated for the N transmission code word groups or transmission block groups are consecutive in a frequency domain, the second signaling includes a total of M parameters representing starting and ending positions of the wireless recourse which is allocated to each transmission code word group or transmission block group, N+1≤M≤2N.

Optionally, the base station configures Physical Downlink Shared Channel Resource Element mapping (PDSCH RE MAPPING) and Quasi-Co-Location (QCL) modes corresponding to each resource scheduling basic unit or resource scheduling basic unit group according to statuses of the wireless resources configured for the N transmission code word groups or transmission block groups respectively.

Optionally, the PDSCH RE MAPPING and QCL modes corresponding to each resource scheduling basic unit or resource scheduling unit group are composed of one or more sets of parameters for configuring the PDSCH RE MAPPING and QCL. The parameters include a cell-specific reference signal (CRS), a channel state information reference signal (CSI-RS), and a demodulation reference signal (DMRS).

The embodiments of the present disclosure provide an apparatus for configuring wireless resource allocation information. The apparatus is used to implement the above embodiments and preferred embodiments, and the description thereof is not elaborated herein. As used below, the term “module” may be a combination of software and/or hardware implementing a predetermined function. Although the apparatuses described in the following embodiment are preferably implemented in software, the implementation by hardware, or by a combination of software and hardware, is also possible and envisaged.

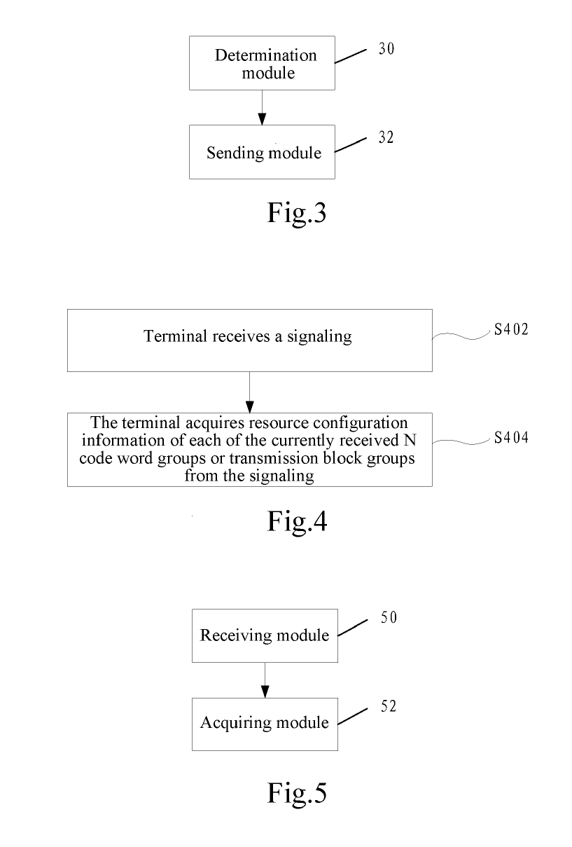

As is shown in FIG. 3, the apparatus includes: a determination module 30, configured to determine wireless resource allocation information to which currently transmitted N transmission code blocks or transmission block groups belong, N≥1; and a sending module 32, configured to send the above wireless resource allocation information to the terminal by a signaling.

Optionally, the sending module 32 is configured to send wireless resource allocation mode groups to which individual N transmission code word groups or transmission block groups belong and wireless resource allocation modes corresponding to individual N transmission code word groups or transmission block groups, to the terminal by a signaling.

The embodiment of the present disclosure also provides a method for configuring wireless resource allocation information. As shown in FIG. 4, the method includes: in S402, a terminal receives a signaling; and in S404, the terminal acquires resource configuration information of the currently received N transmission code word groups or transmission block groups from the signaling.

Optionally, the terminal acquires, by demodulating the signaling, packet information (grouping information) of the currently received N transmission code word groups or transmission block groups.

Optionally, the terminal acquires, by demodulating the signaling, a single base station or multiple base station transmission configuration employed by the currently received N transmission code word groups or transmission block groups.

Optionally, the terminal acquiring the wireless resource configuration information of the currently received N transmission code word groups or transmission block groups by the signaling, includes: acquiring, by the terminal, a wireless resource allocation mode group to which the currently received N transmission code word groups or transmission block groups belong by demodulating a first signaling.

Optionally, the terminal acquiring the wireless resource configuration information of the currently received N transmission code word groups or transmission block groups by the signaling, includes: acquiring, by the terminal, an intra-group wireless resource allocation mode corresponding to the transmission code word groups or transmission block groups which belong to the same wireless resource allocation mode group by demodulating a second signaling. The wireless resource allocation mode includes: the wireless resources are completely overlapping, the wireless resources are partially overlapping, and the wireless resources are completely non-overlapping.

Optionally, the terminal acquiring the wireless resource configuration information of the currently received N transmission code word groups or transmission block groups by the signaling, includes: acquiring, by the terminal, resource allocation basic unit information or resource allocation basic unit group information occupied by each transmission code word group or transmission block group currently received through demodulating the signaling.

Optionally, the resource allocation basic unit information or the resource allocation basic unit group information includes:

when the wireless resources allocated for the N transmission code word groups or transmission block groups adopt the completely overlapping mode, whether each resource allocation basic unit or resource allocation basic unit group is scheduled;

when the wireless resources allocated for the N transmission code word groups or transmission block groups adopt the completely overlapping mode, the number of the same resource groups in mutually independent K transmission code word groups or transmission block groups to which the N transmission code word groups or transmission block groups are allocated, K≥N;

when the wireless resources allocated for the N transmission code word groups or transmission block groups adopt the completely non-overlapping mode, N+1 states corresponding to each resource allocation basic unit or unit group, the N+1 states referring to that one resource allocation basic unit or resource allocation basic unit group is not scheduled, N resource allocation basic units or resource allocation basic unit groups are scheduled to a N^{th} transmission code word group or transmission block group;

when the wireless resources allocated for the N transmission code word groups or transmission block groups adopt the completely non-overlapping mode, a resource group number of mutually independent K group wireless resources to which each transmission code word group or transmission block group is allocated and a mapping mode of the wireless resource group to one transmission code word group or transmission block group;

when the wireless resources allocated for the N transmission code word groups or transmission block groups adopt the partially overlapping mode, a n^{th} set of content corresponding to a n^{th} code word or transmission block group, the n^{th} set of content comprising whether each resource allocation basic unit or resource allocation basic unit group is allocated to the n^{th} transmission code word group or transmission block group, 1≤n≤N; and

when the wireless resources allocated for the N transmission code word groups or transmission block groups adopt a continuous mode, M parameters used for indicating a starting position and an ending position of the wireless resource allocated to each code block or transmission block group, N+1≤M≤2N.

Optionally, the terminal acquires, by demodulating the signaling, a wireless resource location occupied by each transmission code word group or transmission block group that is currently received.

Optionally, the terminal determines the corresponding PDSCH RE MAPPING and QCL modes according to a condition of each resource scheduling basic unit or unit group occupied by each code word.

Optionally, the terminal determines that the PDSCH RE MAPPING and QCL mode corresponding to each resource scheduling basic unit or unit group includes a combination of one or more sets of parameters for configuring the PDSCH RE MAPPING and QCL, and the parameters include: CRS, CSI-RS, DMRS.

According to another aspect of the embodiments of the present disclosure, there is provided an apparatus for configuring wireless resource allocation information, which is applied to a terminal. As shown in FIG. 5, the apparatus includes: a receiving module 50, configured to receive a signaling; and an acquiring module 52, configured to acquire resource configuration information of currently received N transmission code word groups or transmission blocks group from the signaling.

Optionally, the acquiring module 52 is further configured to acquire, by demodulating the signaling, packet information of the currently received N transmission code word groups or transmission block groups.

Hereinafter, the detailed explanations will be given with reference to the specific embodiments.

According to an embodiment of the present disclosure, a method for transmitting a resource configuration signaling is provided.

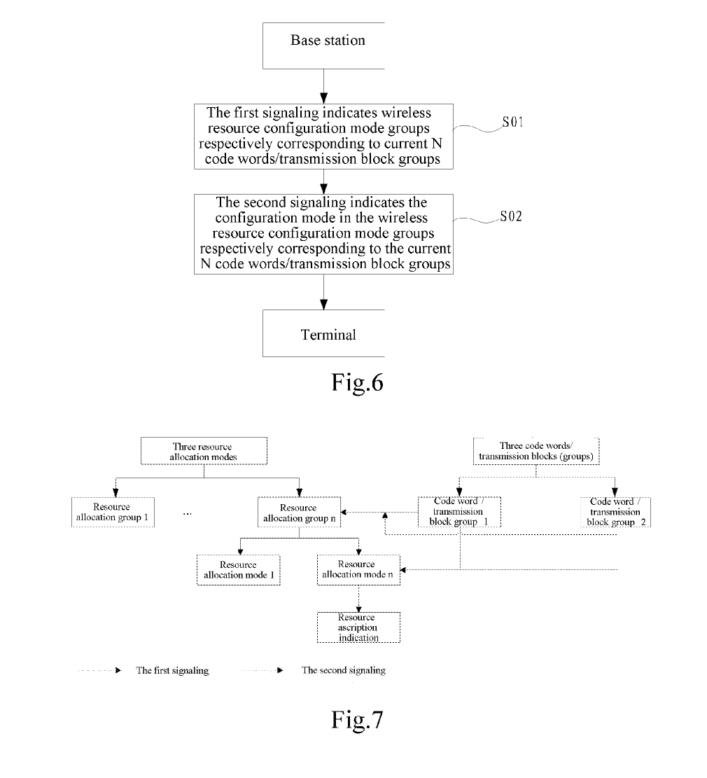

FIG. 6 is a flowchart of performing resource configuration related signaling transmission according to the present disclosure based on the wireless resource allocation mode shown in FIG. 1, and the method mainly includes the following steps (S01 and S02).

In step S01, a base station indicates, by a first signaling, a wireless resource allocation mode group to which the currently transmitted N transmission code words/transmission block groups belong. The mode group includes, but is not limited to, a mode group composed of a combination of three different resource pairing modes in FIG. 1.

In step S02, the base station indicates, by a second signaling, information such as the configuration method in a wireless resource allocation mode group to which the currently transmitted N transmission code words/transmission block groups belong.

Optionally, when there is only one transmission mode included in FIG. 1 in each wireless resource configuration mode group, the step S01 and the step S02 may be combined.

Through the above steps, the base station can flexibly indicate the resource distribution mode corresponding to each transmission code word/transmission block (group), realize on-demand allocation of system resources, and improve performance.

The method shown in FIG. 6 will be described in detail with reference to specific first example, second example and third example.

### First Example

In this example, at the transmission side, there are totally three code words/transmission blocks (groups) needing to be transmitted. According to the modes listed in the present disclosure, the three code words/transmission blocks (groups) may be divided into two code words/transmission blocks (groups) as shown in FIG. 7. The first group contains two code words/transmission blocks (groups), the second group contains one code word/transmission block (group), and the code words/transmission blocks (groups) belonging to the same group use the same resource configuration.

Optionally, the three code words/transmission blocks (groups) may be divided into one code word/transmission block group or three code words/transmission block groups.

Optionally, the obtained code word(s)/transmission block group(s) may be transmitted by one or more TPs.

For each code word/transmission block group, as shown in FIG. 7, a first signaling is composed of 3 (┌log₂(7)┐) bits, and is used to represent a group number of a resource allocation mode group to which the code word/transmission group block belongs, as is shown in Table 1.

TABLE 1
Bit mapping table of group number of resource allocation mode group

| its | resource allocation mode group number |
|---|---|
| 00 | Reserved |
| 01 | 1 |
| 10 | 2 |
| 11 | 3 |
| 00 | 4 |
| 01 | 5 |
| 10 | 6 |
| 11 | 7 |

Under the indication of the first signaling shown in FIG. 7, it is necessary to use a second signaling to respectively indicate a specific resource allocation mode included in the resource allocation mode group indicated by the first signaling corresponding to the code word/transmission block group, and a specific resource ascription indication bit in this mode.

At current, there are 15 available wireless resource basic units (groups), for the two code words/transmission groups belonging to the same resource mapping mode shown in FIG. 7, the content of the resource ascription bit contained in the corresponding second signaling is as follows.

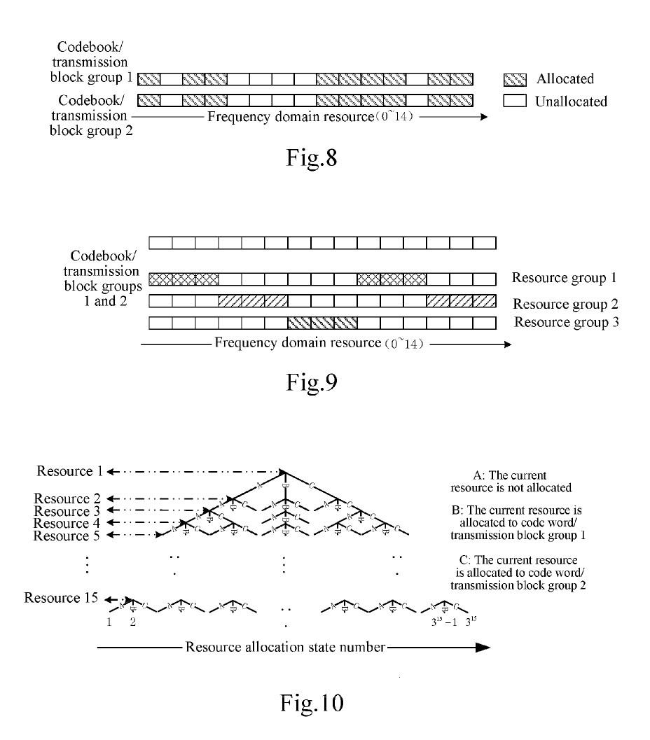

Optionally, when the wireless resource allocation mode indicated by the second signaling to which the code word/transmission group belongs is completely overlapping, the resource attribution indication bit (15 bits) included in the second signaling needs to represent one by one whether each wireless resource basic unit (group) is configured, where 0 means being configured and 1 means not being configured. For example, 101100001111011 represents the resource configuration shown in FIG. 8.

Optionally, when the wireless resource allocation mode indicated by the second signaling to which the code word/transmission group belongs is completely overlapping, the available wireless resources are divided into K (K≥2) groups according to an agreed way. Each code word/transmission block group is allocated to the same resource group, and the resource attribution indication bit included in the second signaling needs to include at least the number of the resource group (┌log₂ (K)┐ bits). For example, 01 indicates the resource configuration shown in FIG. 9.

Optionally, based on the resource configuration shown in FIG. 9, the number of bits may be increased to indicate whether each basic resource scheduling unit in each resource group is scheduled, thereby implementing more detailed resource allocation.

Optionally, when the wireless resource allocation mode indicated by the second signaling to which the code word/transmission group belongs is completely non-overlapping, the resource attribution indication bit (24 (┌log₂(3¹⁵)┐) bits) included in the second signaling needs to represent all the resource allocation states shown in FIG. 10 one by one according to the numbers, totally of 3¹⁵ states. Each state in the state set is generated by three states corresponding to each resource allocation basic unit or unit group nested in a ternary tree manner. These three states specifically refer to that one resource allocation basic unit or unit group is not scheduled, is scheduled to the first code word/transmission block group, and is scheduled to the second code word/transmission block group. The bit mapping relationship corresponding to each state is shown in Table 2.

TABLE 1
Bit mapping table of resource allocation state

| | State | |
|---|---|---|
| Bits | number | State content |
| 000000000000000000000000 | 1 | 15 resources are not allocated |
| 000000000000000000000001 | 2 | 1~14 resources are not allocated, |
| | | and the 15^{th} resource is allocated |
| | | to the first code word/ |
| | | transmission group |
| . | . | . |
| . | . | . |
| . | . | . |
| 111111111111111111111111 | 315 | 15 resources are all allocated |
| | | to the second code word/ |
| | | transmission group |

Optionally, when the wireless resource allocation mode indicated by the second signaling to which the code word/transmission group belongs is completely non-overlapping, the available wireless resources are divided into K (K≥2) groups according to a conventional way. Each code word/transmission block group is allocated to mutually independent resource groups, and the resource attribution indication bit included in the second signaling needs to include at least a resource group number (2┌log₂(K)┐ bits) corresponding to each code word/transmission group.

For example,

$$\underbrace{01}_{No . 1} \underbrace{11}_{No . 2}$$

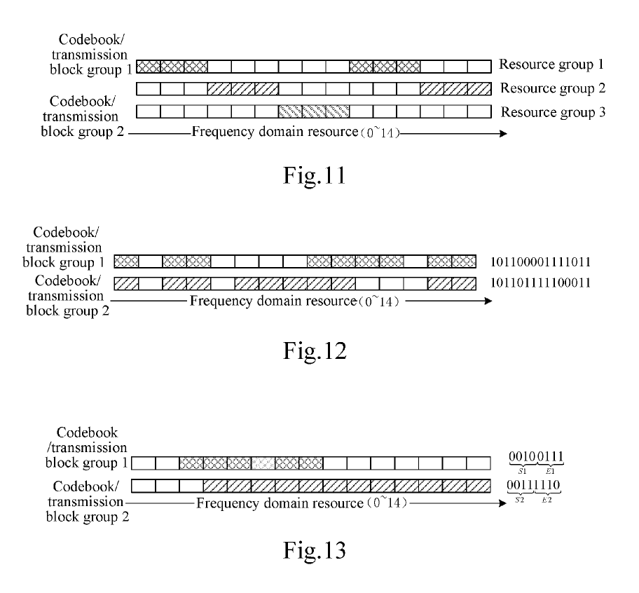

represents the resource configuration shown in FIG. 11.

Optionally, based on the resource configuration shown in FIG. 11, the number of bits may be increased to indicate whether each basic resource scheduling unit in each resource group is scheduled, thereby implementing more detailed resource allocation.

Optionally, when the wireless resource allocation mode indicated by the second signaling to which the code word/transmission group belongs is the partially overlapping mode, the resource attribution indication bit included in the second signaling needs to include two sets of contents (30 (2.15) bits) of the same format to respectively indicate whether each resource allocation basic unit or unit group is assigned to the first or second code word/transmission block group. For example,

$$\underbrace{101100001111011}_{No . 1} \underbrace{101101111100011}_{No . 2}$$

represents the resource configuration shown in FIG. 12.

Optionally, when the wireless resource allocation mode indicated by the second signaling to which the code word/transmission group belongs is the continuous mode, the resource attribution indication bit included in the second signaling needs a parameter (m bits, where m≤4·┌log₂(15)┐) capable of indicating starting and ending positions of the wireless resource allocated to each code word/transmission block group.

For example,

$$\underbrace{0010}_{S 1} \underbrace{0111}_{E 1} \underbrace{0011}_{S 2} \underbrace{1111}_{E 2}$$

represents the resource configuration shown in FIG. 13.

Optionally, on the basis of the resource configuration shown in FIG. 13, if it is agreed that the starting position of the wireless resource allocated to each code word/transmission block group is the same as the ending position of the previous code word/transmission block group, the number of bits used can be reduced to 3·┌log₂(15)┐.

Optionally, on the basis of the resource configuration shown in FIG. 13, if the wireless resources allocated for individual code words/transmission block groups are completely overlapped, the number of bits used may be reduced to 2·┌log₂(15)┐.

### Second Example

In this example, there are totally two code words/transmission blocks (groups) at the transmission side that need to be transmitted. According to the modes listed in the present disclosure, as shown in FIG. 7, the two code words/transmission blocks (groups) are divided into two code words/transmission block groups, and each code word/transmission block group is transmitted by a separate transmission node.

According to the agreement, the resource configuration mode shown in FIG. 1 may be divided into two groups according to whether there is a partially overlapping: completely overlapping/non-overlapping belonging to the first group, and partially overlapping belonging to the second group;

Optionally, completely overlapping/non-overlapping belongs to one group, and overlapping/non-overlapping/partial overlapping belongs to the second group.

For each code word/transmission block group, the first signaling consists of 1 bit, which is used to indicate whether the allocated resource mode group contains a partially overlapping resource allocation mode, where 0 means not containing and 1 means containing.

At current, there are totally I available wireless resource basic units (groups). According to different contents contained in the first signaling, the composition of the second signaling is as shown in Table 3.

TABLE 2
Composition of the second signaling

| | Second signaling | |
|---|---|---|
| | Intra-group | |
| First signaling | distribution mode | Resource attribution indication bit |
| 0 | 0: overlapping | mode1: I bits |
| | | mode 2: may be configured |
| | | mode 3: 2 · ┌log₂(I)┐ |
| | 1: non-overlapping | mode 1: ┌log₂(3^{I})┐ |
| | | mode 2: may be configured |
| | | mode 3: |
| | | 3 · ┌log₂(I)┐or4 · ┌log₂(I)┐ |
| 1 | \ | mode 1: 2I (optimal) |

When the bit of the first signaling is 0, and the allocation mode representation bit in the second signaling group is also 0:

The mode 1 corresponding to the resource attribution indication bit included in the second signaling is: it is required to use I bits to respectively represent whether each wireless resource basic unit (group) is configured to the current code word/transmission block group, where 0 means being configured and 1 means not being configured. For example, 101100001111011 represents the resource configuration shown in FIG. 8.

The mode 2 corresponding to the resource attribution indication bit included in the second signaling is: the available wireless resources are divided into K (K≥2) groups according to conventional way. Each code word/transmission block group is assigned to the same resource group. the resource group number (┌log₂(K)┐) distributed by the resource attribution indication bit included in the second signaling, such as 01, represents the resource configuration shown in FIG. 9. Optionally, based on the resource configuration shown in FIG. 9, the number of bits may be increased to indicate whether each basic resource scheduling unit in each resource group is scheduled, thereby implementing more detailed resource allocation.

The mode 3 corresponding to the resource attribution indication bit included in the second signaling is: for wireless resources configured in a continuous mode, the resource attribution indicator bits (2·┌log₂(I)┐ bits) included in the second signaling need parameters capable of representing starting and ending positions of the wireless resource allocated to the current two code words/transmission block groups.

When the first signaling bit is 0, and the allocation mode representation bit in the second signaling group is 1:

The mode 1 corresponding to the resource attribution indication bit included in the second signaling is: the resource attribution indication bits ((log₂(3^{I})) bits) included in the second signaling needs to represent all the states of the resource allocation one by one according to the number, totally of 3^{I} states. Each state in the state set is generated by three states corresponding to each resource allocation basic unit or unit group nested in a ternary tree mode. These three states specifically refer to one resource allocation basic unit or unit group is not scheduled, is scheduled to the first code word/transmission block group, and is scheduled to the second code word/transmission block group. For example, the bit mapping relationship corresponding to each state is shown in Table 2 and FIG. 10.

The mode 2 corresponding to the resource attribution indication bit included in the second signaling is: the available I wireless resources are divided into K (K≥2) groups according to a conventional way. Each code word/transmission block group is assigned to the mutually independent resource groups. The resource attribution indication bit included in the second signaling needs to include at least the resource group number corresponding to each code word/transmission group. For example,

$$\underbrace{01}_{No . 1} \underbrace{11}_{No . 2}$$

represents the resource configuration shown in FIG. 11. Optionally, based on the resource configuration shown in FIG. 9, the number of bits may be increased to indicate whether each basic resource scheduling unit in each resource group is scheduled, thereby implementing more detailed resource allocation.

The mode 3 corresponding to the resource attribution indication bit included in the second signaling is:

when each code word/transmission group uses a continuous resource allocation method, and optionally, if it is agreed that the starting position of the wireless resource allocated to each code word/transmission block group is different from the ending position of the previous code word/transmission block group, the resource attribution indication bit included in the second signaling needs a parameter (4·┌log₂(I)┐) capable of indicating the starting and ending positions of the wireless resources allocated to each code word/transmission block group.

For example,

$$\underbrace{0010}_{S 1} \underbrace{0111}_{E 1} \underbrace{0011}_{S 2} \underbrace{1111}_{E 2}$$

represents the resource configuration shown in FIG. 13.

Optionally, based on the resource configuration shown in FIG. 13, if it is agreed that the starting position of the wireless resource allocated to each code word/transmission block group is the same as the ending position of the previous code word/transmission block group, the number of bits used can be reduced to 3·┌log₂(15)┐.

When the first signaling bit is 0:

the mode 1 corresponding to the resource attribution indication bit included in the second signaling is: preferably, the resource attribution indication bit (2I) included in the second signaling uses two sets of contents in the same format. Each set of content contains I bits to indicate whether each resource allocation base unit or unit group is assigned to the code word/transmission block group corresponding to the content of the set.

For example,

$$\underbrace{101100001111011}_{No . 1} \underbrace{101101111100011}_{No . 2}$$

represents the resource configuration shown in FIG. 12.

### Third Example

In this example, there are two code words/transmission blocks (groups) at the transmission side that need to be transmitted. According to the modes listed in the present disclosure, the two code words/transmission blocks (groups) may be divided into two code words/transmission block groups, and each code word/transmission block group is transmitted by different transmission nodes.

The second signaling needs to indicate the PDSCH RE MAPPING and QCL states corresponding to the wireless basic unit or group according to the situation of each wireless resource allocation basic unit or group occupied by different code words/transmission block groups, but is not limited thereto.

Optionally, if and only if one or more wireless resource allocation basic units or groups are occupied by one of the above two code words/transmission block groups, the PDSCH RE MAPPING and QCL states corresponding to this resource are determined by the PDSCH RE MAPPING and QCL parameters used when transmitting the code word/transmission block group, and the parameters include, but are not limited to, a port number corresponding to the CRS and DMRS, a starting position of resource mapping of the PDSCH, and the QCL correspondence between the ports of the CRS and the DMRS.

Optionally, if and only if one or more wireless resource allocation basic units or groups are occupied by one of the above two code words/transmission block groups, the PDSCH RE MAPPING and QCL states corresponding to the resource are determined by the PDSCH RE MAPPING and QCL parameters used when transmitting the two code words/transmission block groups, and the parameters include, but are not limited to, the port number corresponding to the CRS and DMRS, the starting position of the resource mapping of the PDSCH, and the QCL correspondence between the ports of the CRS and the DMRS.

Through the description of the above embodiments, those skilled in the art can clearly understand that the method according to the above embodiments can be implemented by means of software plus a necessary general hardware platform, and may also be implemented by hardware. However, in many cases, the former is a better implementation manner. Based on such understanding, the essential portion of the technical solution of the present disclosure or the portion contributing to the related art can be implemented in the form of a software product. The computer software product is stored in a storage medium (such as a ROM/RAM, a magnetic disk, and an optical disk), and includes several instructions for causing a terminal device (which may be a mobile phone, a computer, a server, or a network device, etc.) to perform the method described in respective embodiments of the present disclosure.

It should be noted that the above individual modules may be implemented by software or hardware. For the latter, the modules may be implemented by, but not limited to, the foregoing manners: the above modules are all located in the same processor; or the above individual modules are located in different processors in any form of combination.

It will be apparent to those skilled in the art that the above-described modules or steps of the present disclosure may be implemented by a general purpose computing device which may be focused on a single computing device or distributed over a network composed of a plurality of computing devices, and optionally may be implemented by a program code executable by the computing device, so that they may be stored in a storage device and executed by the computing device. In some cases, the steps shown or described may be performed in an order different from here; or they are separately made into individual integrated circuit modules, or multiple modules or steps in them are made into a single integrated circuit module. In this way, the present disclosure is not limited to any particular combination of hardware and software.

Those described above are merely optional embodiment of the present disclosure, but are not intended to limit the present disclosure. For those skilled in the art, the present disclosure may have various modifications and changes. Any modifications, equivalent substitutions and improvements made without departing from the spirit and principle of the present disclosure shall all fall within the scope of protection of the present disclosure.

### INDUSTRIAL APPLICABILITY

In the embodiments of the present disclosure, the base station sends, to the terminal by the signaling, wireless resource allocation information to which currently-transmitted N transmission code word groups and transmission block groups belong, therefore, the resources occupied by the plurality of code words/transmission blocks respectively can be adaptively configured according to the current system/TP load, channel characteristics fed back by different links, and the like. The problem of not implementing signaling configuration related to resource configuration in the related art can be solved.

1.-31. (canceled)

32. A method for configuring wireless resource allocation information, comprising:
sending, by a base station, wireless resource allocation information to which currently-transmitted N transmission code word groups or transmission block groups belong respectively, to a terminal via a signaling, where N≥1.

33. The method according to claim 32, wherein, the sending, by the base station, the wireless resource allocation information to which the currently-transmitted N transmission code word groups or transmission block groups belong respectively, to the terminal via the signaling, comprises:
sending, by the base station, wireless resource allocation mode groups to which the N transmission code word groups or transmission block groups belong respectively, and wireless resource allocation modes to which the N transmission code word groups or transmission block groups respectively correspond, to the terminal, and
wherein a wireless resource allocation mode used for allocating a wireless resource for each transmission code word group or transmission block group, comprises at least one of followings: the wireless resource completely overlapping, the wireless resource partially overlapping, or the wireless resource completely non-overlapping.

34. The method according to claim 32, wherein:
the N code word groups or transmission block groups are jointly transmitted by one or more base stations.

35. The method according to claim 32, wherein:
N transmission code word groups or transmission block groups are allocated with a wireless resource in a form of a resource allocation basic unit or a resource allocation basic unit group.

36. The method according to claim 33, wherein the sending, by the base station, the wireless resource allocation information to which the currently-transmitted N transmission code word groups or transmission block groups belong respectively, to the terminal via the signaling, comprises:
sending, by the base station, the wireless resource allocation mode groups to the terminal via a first signaling; and
sending, by the base station, the wireless resource allocation modes via a second signaling.

37. The method according to claim 35, wherein:
when the wireless resources allocated for the N transmission code word groups or transmission block groups respectively use the completely overlapping mode, a second signaling carries indication information indicating whether each resource allocation basic unit or resource allocation basic unit group is scheduled, or
when the wireless resources allocated for the N transmission code word groups or transmission block groups respectively use the completely overlapping mode, dividing the wireless resources into mutually independent K groups, the second signaling carrying a resource group number comprising the wireless resource allocation mode group corresponding to the current N transmission code word groups or transmission block groups, where K≥N, or
when the wireless resources allocated for the N transmission code word groups or transmission block groups use the completely non-overlapping mode, the second signaling carries N+1 states of a resource allocation basic unit or a resource allocation basic unit group, the N+1 states referring to that one resource allocation basic unit or resource allocation basic unit group is not scheduled, or is scheduled to a n^{th} transmission code word group or transmission block group, where 1≤n≤N, or
when the wireless resources allocated for the N transmission code word groups or transmission block groups respectively use the completely non-overlapping mode, the wireless resources are divided into mutually independent N groups, and are allocated to N transmission code word groups or transmission block groups in a non-multiplexed mapping mode, the non-multiplexed mapping mode comprising a one-to-one mapping mode between a wireless resource group and the transmission code word group or transmission block group, where K≥N; and
the second signaling comprises a resource group number corresponding to each transmission code word group or transmission block group, or
when the wireless resources allocated for the N transmission code word groups or transmission block groups respectively use the partially overlapping mode, the second signaling comprises N sets of contents having the same or different formats for characterizing resource features allocated for corresponding transmission code word groups or transmission block groups one by one, a n^{th} set of content comprising two states of whether each resource allocation basic unit or resource allocation basic unit group is allocated to a n^{th} transmission code word group or transmission block group, where 1≤n≤N, or
when the wireless resources allocated for the N transmission code word groups or transmission block groups respectively are consecutive in a frequency domain, the second signaling comprises a total of M parameters representing a starting position and an ending position of the wireless resource which is allocated to each transmission code word group or transmission block group, where N+1≤M≤2N.

38. The method according to claim 32, wherein:
the base station configures a Physical Downlink Shared Channel Resource Element mapping (PDSCH RE MAPPING) and Quasi-Co-Location (QCL) mode corresponding to each resource scheduling basic unit or resource scheduling basic unit group according to statuses of the wireless resources configured for the N transmission code word groups or transmission block groups respectively.

39. A method for configuring wireless resource allocation information, comprising:
receiving a signaling by a terminal; and
acquiring, by the terminal, resource configuration information of currently received N transmission code word groups or transmission block groups from the signaling.

40. The method according to claim 39, wherein:
the terminal acquires a single base station or multiple base station transmission configuration used by the currently received N transmission code word groups or transmission block groups by demodulating the signaling.

41. The method according to claim 39, wherein the acquiring, by the terminal, the wireless resource configuration information of the currently received N transmission code word groups or transmission block groups by using the signaling, comprises:
acquiring, by the terminal, wireless resource allocation mode groups to which the currently received N transmission code word groups or transmission block groups belong respectively by demodulating a first signaling.

42. The method according to claim 39, wherein the acquiring, by the terminal, the wireless resource configuration information of the currently received N transmission code word groups or transmission block groups by using the signaling, comprises:
acquiring, by the terminal, an intra-group wireless resource allocation mode corresponding to the transmission code word groups or transmission block groups that belong to the same wireless resource allocation mode group by demodulating a second signaling, the wireless resource allocation mode comprising: the wireless resources completely overlapping, the wireless resources partially overlapping, and the wireless resources completely non-overlapping.

43. The method according to claim 39, wherein the acquiring, by the terminal, the wireless resource configuration information of the currently received N transmission code word groups or transmission block groups by using the signaling, comprises: acquiring, by the terminal, resource allocation basic unit information or resource allocation basic unit group information occupied by each of the currently received transmission code word group or transmission block group by demodulating the signaling.

44. The method according to claim 43, wherein the resource allocation basic unit information or the resource allocation basic unit group information comprises:
when the wireless resources allocated for the N transmission code word groups or transmission block groups respectively use the completely overlapping mode, whether each resource allocation basic unit or resource allocation basic unit group is scheduled;
when the wireless resources allocated for the N transmission code word groups or transmission block groups respectively use the completely overlapping mode, a number of the same resource group in mutually independent K transmission code word groups or transmission block groups to which the N transmission code word groups or transmission block groups are allocated, K≥N;
when the wireless resources allocated for the N transmission code word groups or transmission block groups respectively use the completely non-overlapping mode, N+1 states corresponding to each resource allocation basic unit or unit group, the N+1 states referring to that one resource allocation basic unit or resource allocation basic unit group is not scheduled, N resource allocation basic units or resource allocation basic unit groups are scheduled to a N^{th} transmission code word group or transmission block group;
when the wireless resources allocated for the N transmission code word groups or transmission block groups respectively use the completely non-overlapping mode, a resource group number of mutually independent K group wireless resources to which each transmission code word group or transmission block group is allocated and a mapping mode of the wireless resource group to one transmission code word group or transmission block group;
when the wireless resources allocated for the N transmission code word groups or transmission block groups use the partially overlapping mode, a n^{th} set of content corresponding to a n^{th} code word or transmission block group, the n^{th} set of content comprising whether each resource allocation basic unit or resource allocation basic unit group is allocated to the n^{th} transmission code word group or transmission block group, 1≤n≤N; and
when the wireless resources allocated for the N transmission code word groups or transmission block groups use a continuous mode, M parameters used for indicating a starting position and an ending position of the wireless resource allocated to each code block or transmission block group, N+1≤M≤2N.

45. The method according to claim 39, wherein the terminal acquires a wireless resource location occupied by each of the currently received transmission code word group or transmission block group by demodulating the signaling.

46. The method according to claim 39, wherein, the terminal determines the corresponding PDSCH RE MAPPING and QCL mode according to a condition of each resource scheduling basic unit or unit group being occupied by each code word.

47. The method according to claim 39, wherein, the terminal determines that a Physical Downlink Shared Channel Resource Element mapping (PDSCH RE MAPPING) and Quasi-Co-Location (QCL) mode corresponding to each resource scheduling basic unit or unit group comprises a combination of one or more sets of parameter for configuring the PDSCH RE MAPPING and QCL, and the parameters comprise: CRS, CSI-RS, and DMRS.

48. An apparatus for configuring wireless resource allocation information, applied to a base station, the apparatus comprising:
a processor; and
a memory for storing instructions executable by the processor;
wherein the processor is configured to send to a terminal by a signaling, wireless resource allocation information to which currently-transmitted N transmission code word groups or transmission block groups belong, N≥1.

49. The apparatus according to claim 48, wherein the processor is further configured to send wireless resource allocation mode groups to which the N transmission code word groups or transmission block groups belongs respectively and wireless resource allocation modes corresponding to the N transmission code word groups or transmission block groups respectively, to the terminal by the signaling.

50. An apparatus for configuring wireless resource allocation information, applied to terminal, the apparatus comprising:
a processor; and
a memory for storing instructions executable by the processor;
wherein the processor is configured to perform the method according to claim 39.

51. The apparatus according to claim 50, wherein the processor is further configured to acquire packet information of the currently received N transmission code word groups or transmission block groups by demodulating the signaling.
